(19) United States
(12) Patent Application Publication
(10) Pub. No.: US 2011/0030619 A1
(43) Pub. Date: Feb. 10, 2011

(54) Litter Apparatus And Training Method

(76) Inventor: Victoria Blackstone, Powder Springs, GA (US)

Correspondence Address: KNOX PATENTS, P.O. BOX 30034, KNOXVILLE, TN, 37930-0034, US

(21) Appl. No.: 12/853,021

(22) Filed: Aug. 9, 2010

Related U.S. Application Data
(60) Provisional application No. 61/232,530, filed on Aug. 10, 2009.

(51) Int. Cl. A01K 1/01; A01K 15/02; A01K 29/00

(52) U.S. Cl. 119/527; 119/712; 119/165

(57) ABSTRACT

An apparatus for receiving waste of domesticated animals is provided that includes a floor that is joined to four walls to define an area of floor space within the apparatus. An opening in one of the walls includes a door for selectively providing access to the apparatus. The apparatus includes a litter box for receiving waste of domesticated animals. The litter box is removable from the enclosure and occupies approximately one-third of the available floor space. A lid is joined to one of the walls and provides for placement and removal of the litter box within the apparatus.

### CROSS-REFERENCE TO RELATED APPLICATIONS

This application claims the benefit of U.S. Provisional Application No. 61/232,530, filed Aug. 10, 2009.

### STATEMENT REGARDING FEDERALLY SPONSORED RESEARCH OR DEVELOPMENT

Not Applicable

### BACKGROUND

1. Field of Invention

This invention pertains to litter boxes for dogs and other animals. More particularly, this invention pertains to a litter box, an enclosure for the litter box, and a method for litter training dogs.

2. Description of the Related Art

For many people, domesticated animals such as dogs are treated as members of the family. Some of these pets live inside the home with the owner. Dog owners in particular have long sought alternatives to taking the dog outside of the home to urinate or defecate, especially during inclement weather. Additionally, there are times when the owner is away from home all day, or at least longer than expected. There are other times when the owner desires to sleep in, or otherwise cannot be disturbed. There are multitudes of occurrences where it would be nice if the dog could take care of its needs to eliminate waste on its own.

For smaller dogs, there are also the inherent dangers of going outside unattended. Toy breeds and small dogs are often more susceptible to injury such as broken bones than are larger dogs. Small dogs are also vulnerable to many predators such as coyotes, hawks, and the like.

One method for litter training dogs is the crate training method. Crate training methods use a crate that is barely large enough to accommodate the dog while standing. There is just enough room for the dog to lie down and turn around. The crate training theory is that the dog will not soil its den (the place where it sleeps). The dog will then hold it until the trainer lets the dog out to relieve itself.

### BRIEF SUMMARY

According to one embodiment of the present invention, an apparatus for receiving waste of domesticated animals is provided that includes a floor that is joined to four walls to define an area of floor space within the apparatus. An opening in one of the walls includes a door for selectively providing access to the apparatus. The apparatus includes a litter box for receiving waste of domesticated animals. The litter box is removable from the enclosure and occupies approximately one-third of the available floor space. A lid is joined to one of the walls and provides for placement and removal of the litter box within the apparatus.

In another embodiment, a litter box for receiving waste of domesticated animals is provided that includes a floor joined to four panels to define a watertight container with a top opening and a passage opening. The height of the first panel is approximately one-fourth the height of the remaining panels so that the passage opening at the first panel provides for entry into and exit from the litter box. The height of the second, third, and fourth panels are of sufficient height to be a barrier for male animals that lift a leg to relieve themselves. The height of the second, third, and fourth panels are of sufficient height to be a barrier whereby kicked litter stays within the litter box upon an animal kicking litter while exiting via the passage opening.

In another embodiment, a method for litter training an animal such as a dog is provided that includes preparing a litter training environment that includes a confined area for the animal. A litter box is selected that includes an opening of low enough height that the animal can enter or leave without stumbling or jumping, and a panel taller than the opening to prevent litter from being kicked out when the animal leaves. A confined area is selected for the litter box. Non-clumping litter is placed in the litter box. The animal is placed in the confined area. The animal is trained for a period until the litter training is complete. A schedule is defined that includes expected elimination times for the animal. The elimination times derive from specified events that occur at regular intervals during the training period, such as waking, feeding, play time, and before sleeping. The animal is placed in the litter box at each expected elimination time, and removed if no elimination occurs. Upon successful elimination, the animal is praised and rewarded. The training continues until it is complete.

### BRIEF DESCRIPTION OF THE SEVERAL VIEWS OF THE DRAWINGS

The above-mentioned features will become more clearly understood from the following detailed description read together with the drawings in which:

FIG. 1 is a perspective view of one embodiment of an apparatus that includes a litter box.

FIG. 2 is a perspective view of one embodiment of a litter box.

FIG. 3 is a side view of the litter box of FIG. 2.

FIG. 4 is a flowchart illustrating one embodiment of a method for litter training a dog.

### DETAILED DESCRIPTION

Methods for litter training dogs via an enclosure and a litter box are disclosed. The litter box has a low threshold for entry/exit and has high side and back panels for keeping the litter and animal waste within the litter box. An enclosure for the dog and the litter box provides a self-contained litter training environment.

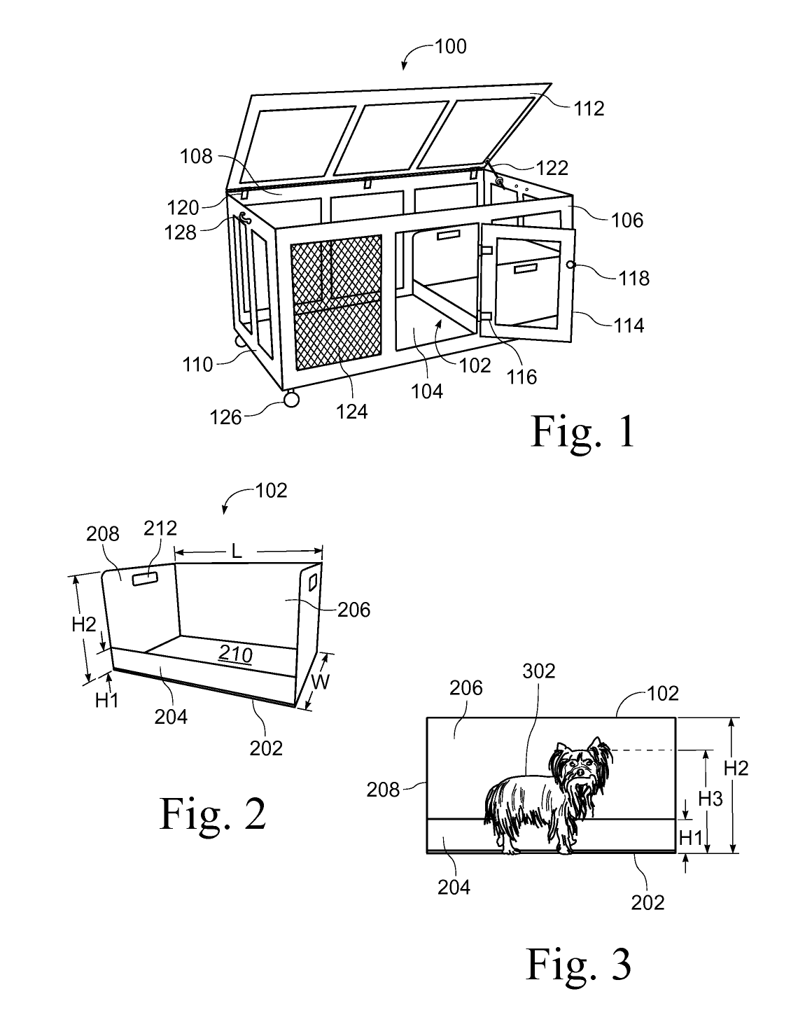

FIG. 1 illustrates a perspective view of one embodiment of an enclosure 100 for dogs and other animals. The enclosure 100 is shown with an accompanying litter box 102. In the illustrated embodiment, the litter box 102 is shown within the enclosure 100. The enclosure 100 is formed from a floor 104, a front wall 106, a back wall 108, two end walls 110, and a lid 112, into an enclosed structure similar to a box or crate. The enclosure 100 is sized for an animal to fit inside, while including ample room for bedding, food and water bowls, toys, and the litter box 102. The floor 104, walls 106, 108, 110, and lid 112, are made from water resistant materials to accommodate for spills and accidents.

The front wall 106 of the enclosure 100 includes a door 114. The door 114 is attached to an opening in the front wall 106 via hinges 116. In the illustrated embodiment, the door 114 is attached with the hinges on the side of the door 114. In another embodiment, the door 114 is attached via hinges at the top of the opening in the front wall 106. In the illustrated embodiment, the door 114 is approximately midway between the two ends of the front wall 106. In other embodiments, the door 114 is located at one end of the front wall 106, or even in an end wall 110.

When closed, the door 114 is secured by a fastener 118. In the illustrated embodiment, the fastener 118 is a latch. In various embodiments, the fastener 118 includes knobs, pulls, hooks, barrel bolts, hasps, and the like. In one embodiment, the door 114 selectively prevents the animal from escaping through the opening in the front wall 106. For example, during the training period, as discussed below, the door 114 is openable by the trainer and not by the animal. After the training period, the door 114 is openable by the animal for entry and exit of the enclosure 100.

A lid 112 seals the top of the enclosure 100. The lid 112 is attached via hinges 120 along the back wall 108. The hinges 120 provide for opening and closing the lid 112. In the illustrated embodiment, three hinges 120 attach the lid to the back wall 108. Other embodiments may include a greater or lesser number of hinges 120 due to design choice, aesthetics, and/or hinge strength, for example. When the lid 112 is open, a lid support 122 maintains the lid 112 in the open position. Opening the lid 112 provides access to the interior of the enclosure 100 and also for removal and/or cleaning of the litter box 102. In the illustrated embodiment, there is no latch for securing the lid 112 in a closed position. Since small dogs are unlikely to have sufficient strength to push the lid 112 open, gravity holds the lid 112 in place. In other embodiments, various type latches and/or fasteners secure the lid 112 in a closed position.

In one embodiment, the enclosure 100 is a fully enclosed structure with a latching door 114 and a latching lid 112 to prevent the animal from escaping. Such an embodiment prevents unintended opening of the enclosure 100, as by small children, for example. In another embodiment, the enclosure 100 includes walls 106, 108, 110, that are sufficiently tall to prevent the animal from escaping by jumping out of the enclosure 100.

In the illustrated embodiment, the lid 112 and each wall of the enclosure 100 are divided into sections 124. That is, the front wall 106, the back wall 108, the end walls 110, and the lid 112, are each divided into sections 124. In the illustrated embodiment, the door 114 corresponds to one section 124 of the front wall 106. The sections 124 of the walls prevent a dog from leaving the enclosure 100 through the walls 106, 108, 110. Each section 124 provides visibility into and out-of the enclosure 100. That is, the walls 106, 108, 110, and lid 112 are made from see-through materials. In the illustrated embodiment, each section 124 includes a wire mesh material. For illustration purposes, only one wire mesh is shown in place for a section 124 in the front wall 106. However, each section 124 of the back wall 108, the end walls 110, the lid 112, and the front wall 106, respectively include a similar wire mesh material. A wire mesh material allows the dog to see outside the enclosure and also keeps the dog from feeling more closed in than it already is. In other embodiments, the sections 124 include fiberglass, lattice, and the like. In still other embodiments, at least some portion of the walls 106, 108, 110, and/or lid 112 are not made from see-through materials. In such embodiments, at least some sections 124 include metal, rigid plastics, plywood, and the like.

The enclosure 100 includes supports 126 and handles 128. In the illustrated embodiment, the supports 126 are casters attached to the underside of the floor 104. In other embodiments, the supports 126 are wheels, legs, levelers, and the like. The handles 128 are attached to each of the end walls 110 on the outside of the enclosure 100. In the illustrated embodiment, the handles 128 are pull handles. In various embodiments, the handles 128 include knobs, drop handles, pendant pulls, ring pulls, recessed pulls, and the like. For the illustrated embodiment, the handles 128 in combination with the casters 126 provide for ease of movement of the enclosure 100.

In one embodiment, the smallest dimension of the enclosure 100 is sized to fit through an opening between two living spaces in a dwelling. In the United States, the opening for interior or passage (room to room) residential doors is commonly 30 inches, though smaller openings were once common. For wheelchair access, such openings are commonly 36 inches. In one such embodiment, the dimension of the end walls 110 of the enclosure 100 is less than 30 inches. In such an embodiment, the enclosure 100 is easily moved from one location to another within a dwelling.

In the illustrated embodiment, the enclosure 100 is sized for a litter box 102 to fit lengthwise across one end of the enclosure 100. Such a litter box 102 uses approximately one-third of the space available in floor 104 of the enclosure 100. The remaining space provides ample room for a dog, bedding, food and water bowls, and toys for the dog to play with. The enclosure 100 provides a self-contained living space for a dog or other animal.

The litter box 102 is removable from the enclosure 100. In one embodiment, the litter box 102 is located on the floor 104 at one end of the enclosure 100. In other embodiments, the litter box 102 is placed in various locations within the enclosure 100.

In the illustrated embodiment, the walls 106, 108, 110, and the lid 112 of the enclosure 100 are made from wood. In other embodiments, the walls 106, 108, 110, and the lid 112 are made from fiberglass, metal, rigid plastics, plywood, and the like. In the illustrated embodiment, the floor 104 is made from thermoplastic acrylonitrile butadiene styrene (ABS). The thermoplastic ABS provides a floor 104 that is lightweight and rigid, while also providing an impervious surface. Such a material is ample as a support for the litter box 102, an animal, and various accoutrements such as bedding, food and water bowls, and toys. In some embodiments, the surface of the floor 104 is smooth. In one embodiment, the floor 104 is made from rigid plastics, fiberglass, metal, plywood, and the like.

FIG. 2 illustrates a perspective view of one embodiment of a litter box 102. FIG. 3 illustrates a side view of a dog 302 standing in front of the litter box 102. The litter box 102 is a container for receiving the waste, urine and feces, of domesticated animals. Such animals are permitted free roam within the home, but either cannot or do not go outside to relieve themselves. The litter box 102 is sized to accommodate an animal such as a dog 302. The litter box 102 defines a volume that is watertight and contains litter. Litter material fills the defined volume of the litter box 102 to a specified depth. Walls extend high above the level of the litter to aid in containing the waste eliminated by the animal. The tall or high walls also prevent the litter from being kicked out of the litter box 102 when the animal exits the litter box 102.

Litter material provides a surface within the litter box 102 for the animal to tread. In particular, litter prevents the pooling of liquids so that the animal does not track the liquid out of the litter box 102. The liquids are absorbed by the litter, or the liquids filter to the lower portions of the container. The litter also prevents fecal matter from adhering to the bottom of the container.

Exemplary types of litter include traditional clay based cat litter, clumping cat litter, bio-degradable cat litter, and silica gel cat litter. Traditional clay based cat litter is not scoopable (does not clump) when soiled but absorbs urine well. It has to be changed often and is dusty. Clumping cat litters are scoopable because they clump together when liquids are added. Since only the clumps are removed, the litter does not have to be changed as often as traditional clay based cat litter, although it does have to be replenished between changes. Bio-degradable litter materials are derived from plant materials, wood, and paper. They are environmentally friendly and potentially flushable. Silica gel is a recently developed cat litter that consists of silica bead or pellets that absorb urine without the need to scoop. When the litter changes color, the entire amount is replaced.

The litter box 102 includes a floor member 202, a front panel 204, a back panel 206, and two end panels 208. In combination, the floor member 202 and panels 204, 206, 208 define a portion of the litter box 102 for receiving litter and/or similar materials.

In the illustrated embodiment, the floor member 202 is of a substantially rectangular shape having dimensions of a length L and a width W. The panels 204, 206, 208 are affixed to and each extends substantially perpendicular from an edge of the floor member 202. The front panel 204 and back panel 206 each have a length L corresponding to the length L of the floor member 202. The front panel 204 is opposite the back panel 206. The end panels 208 have a width W corresponding to the width W of the floor member 202. The end panels 208 are opposite each other and are each adjacent to both the front panel 204 and the back panel 206. The height H2 of the back panel 206 and end panels 208 exceeds the height H1 of the front panel 204 so that the front panel 204 forms an opening or passageway into the litter box 102. The opening at the front panel 204 provides for entry into and exit from the litter box 102 by dogs 302 and/or other animals.

In one embodiment, the floor member 202 and the panels 204, 206, 208 are joined to form a watertight container. The watertight container prevents urine and/or other liquids from escaping through the litter box 102. In one embodiment, the floor surface 210 is smooth. A smooth floor surface 210 provides for easier and more hygienic cleanup of the litter box 102. In another such embodiment, the inside surfaces of the panels 204, 206, 208 are also smooth. In another embodiment, the surfaces of the panels 204, 206, 208 on the outside of the litter box 102 are textured.

In one embodiment, the floor panel 202, the back panel 206, and the end panels 208 are made from a durable material that is substantially impervious to damage from the waste elimination, weight, scratching, pounding, and/or other by-products of animal behavior.

In one embodiment, the floor member 202 and the panels 204, 206, 208 are made from thermoplastic ABS and are joined at their edges via an ABS cement bonding agent. In other embodiments, the floor member 202 and the panels 204, 206, 208 are made from rigid plastics, fiberglass, metal, plywood, and the like.

Each end panel 208 includes a handle 212 near the edge distal from the floor member 202. The handles 212 are more readily accessible due to the height of the end panels 208. Easily accessible handles 212 provide for hygienic portability of the litter box 102. That is the litter box 102 can be moved without having to handle those portions of the litter box 102 that have likely been soiled by animal waste. In the illustrated embodiment, the handles 212 are cut out of each end panel 208. In one embodiment, the handles 212 are cut to a length of approximately 5 inches. In other embodiments, the handles 212 are knobs, pull handles, and the like, affixed to each end panel 208.

In one such embodiment, the litter box 102 has dimensions of 22 inches length, 15 inches width, and 12 inches height, with a front panel 102 that has 3 inches height. Such an embodiment is suitable for small breed dogs 302 such as Yorkshire Terriers, Chihuahuas, Pekingese, Shih Tzu, Toy Poodles, and other similarly sized dogs 302. The litter box 102 is sized appropriately for small breed and toy dogs 302 and other small animals. The shallow entrance opening at the front panel 204 is short enough that young puppies can easily enter or exit the litter box 102 without risk of stumbling or injury.

In another embodiment, the length L (i.e., front panel 204, back panel 206) is approximately 50% greater than the width W (i.e., end panels 208), the width W is approximately 25% greater than the height H2 (i.e., back panel 206, end panels 208), and the height H1 of the front panel 204 is approximately one-fourth of the height H2 of the back panel 206 and end panels 208. In one such embodiment, the height H1 of the front panel 204 is approximately one-third the height H3 of a dog 302 for which the litter box 102 is intended.

In another embodiment, the height H1 is such that a dog 302 can enter or exit the litter box 102 without having to jump or scrape its abdomen on the front panel 204. That is, the height H1 is less than the distance from the floor to the most ventral point of the abdomen for a dog 302 standing on all four legs. In one such embodiment, the height H2 of the litter box 102 exceeds the height H3 of the dog 302.

The height H2 of the back panel 206 and the end panels 208 provides for a hygienic environment. Some male dogs 302 lift a leg to relieve themselves rather than squatting. Without a sufficient barrier, some or all of the urine can wind up on a floor or carpet. The back panel 206 and end panels 208 provide an effective splash screen to accommodate such male dog 302 activity. The height H2 defines a continuous barrier that keeps the urine within the litter box 102.

The height H2 of the back panel 206 and the end panels 208 also contain the litter within the litter box 102 when the dog 302 exits. As a dog 302 jumps out of the litter box 102, their hind feet kick some of the litter behind them. Without a sufficient barrier, a portion of the kicked litter winds up on the floor. The back panel 206 and end panels 208 provide a barrier that prevents the kicked litter from leaving the litter box 102.

The back panel 206 and the end panels 208 provide a support for aging or handicapped dogs within the litter box 102. As animals age or become arthritic, they sometimes have difficulty balancing while either squatting or lifting a leg to eliminate. In such cases, an animal sometimes stumbles or falls while attempting to eliminate. In one embodiment, the back panel 206 and the end panels 208 are formed from materials having sufficient rigidity and height H2 to support or brace an animal leaning on the panels 206, 208. That is, when an animal leans on a panel 206, 208, the respective panel 206, 208 does not bend or flex in a manner that compromises the stability of the animal, and the animal is able to eliminate without stumbling or falling.

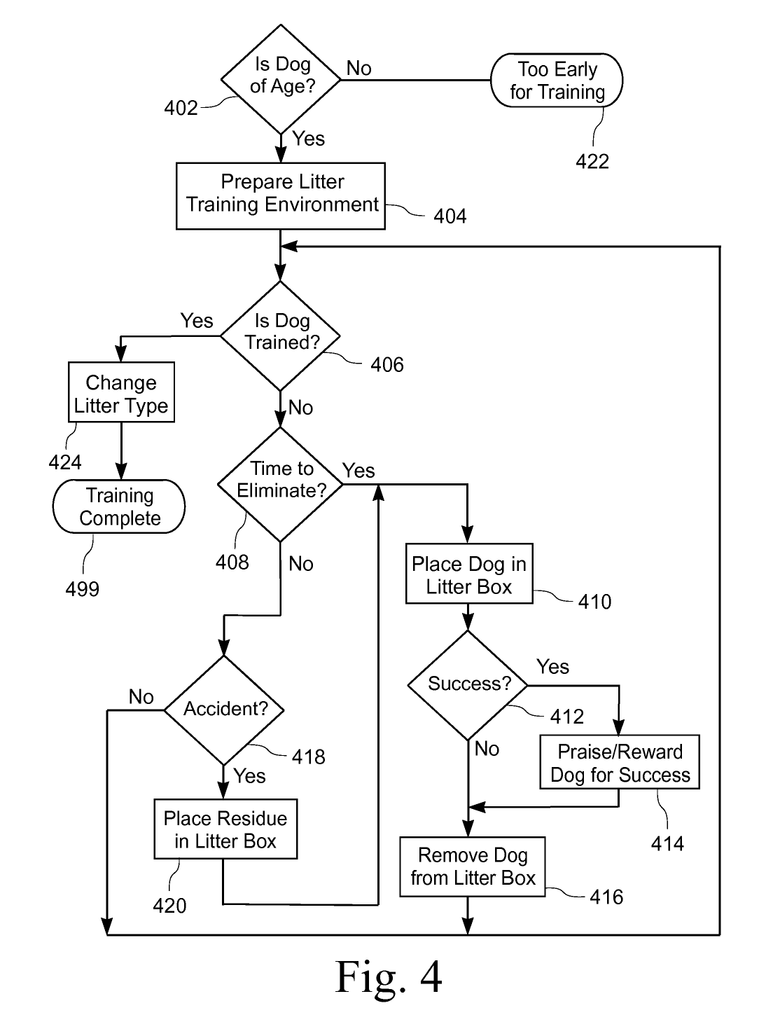

FIG. 4 is a flowchart illustrating one embodiment of a method for litter training a dog 302. Training a dog 302 to use a litter box 102 is an interactive process that begins with a determination of whether the dog 302 is old enough to begin the training at step 402. In some embodiments, litter training a dog 302 begins at an age of 10-12 weeks. In other embodiments, dogs 302 are litter trained beginning at an earlier age. In such embodiments, litter training is not as simple and requires additional patience on the part of the trainer. Leaving a puppy with their mother for a few extra weeks often leads to better-adjusted puppies and the training process is simpler and faster. In other embodiments, the litter training of older dogs 302 begins by placing the enclosure 100 in a location where the dog 302 customarily eliminates waste. In one such embodiment, a litter box 102 is used without an enclosure 100. In such an embodiment, the dog 302 is already trained to an area (i.e., newspaper or puppy pads) and simply requires re-training to use the litter box 100.

If the dog is old enough to begin the litter training process, preparation of a litter training environment begins as in step 404. A training environment is a limited area in which the dog 302 is allowed to roam. In one embodiment, the training environment is the enclosure 100 described above. In another embodiment, the training environment is a confined space such as a laundry room or kitchen.

In one embodiment, preparation of the training environment 402 includes placing the enclosure 100 in locations near the trainer or family. Dogs 302 are pack animals and prefer being with their pack/family. A bedroom, kitchen, or family room is a good location for the enclosure 100, whereas remote locations such as garages, laundry rooms, or an unused basement are less desirable. Locating the enclosure near the trainer reduces the frequency of “stress urinating” that some dogs 302 experience due to separation anxiety.

The litter box 102 is placed in one end of the enclosure 100. After placement, non-clumping litter is added to the litter box 102. Dogs 302 often play in their water bowl and clumping litter often sticks to their wet feet. The dog 302 then tracks the litter throughout the enclosure 100. Once the training period is complete, any type litter is suitable. The type of litter can be changed gradually by incorporating small amounts into the previously used litter every few days until the litter is completely changed. Since dogs 302 do not bury their wastes, the layer of litter does not need to be very thick. For example, small breed and toy dogs only require a couple inches of litter within the litter box 102.

The dog 302 is placed into the enclosure 100 along with bedding, toys, and food and water bowls, for the training period. Young dogs 302 or puppies sometimes bark or whine when placed in the enclosure 100. The dog 302 is left in the enclosure 100 during any whining or barking. Otherwise, bad behavior is encouraged so that the dog 302 is training the master. Any barking or whining is ignored and the dog 302 is taken out of the enclosure 100 during times when they are quiet.

The dog 302 is also comforted by leaving something with them that smells like their master/trainer. For example, the trainer keeps a handkerchief inside their shirt for a day. The handkerchief then smells like the trainer and is left with the dog 302 to ease their loneliness for a period.

A periodic evaluation of whether the dog 302 is adequately litter trained is performed in step 406. Once the dog 302 has adjusted to the litter box 102 as the place to eliminate, the litter type can be changed from non-clumping litter at step 424. Changing the litter type is performed by gradually mixing in the new litter type with the old over a period of time. The dog 302 adjusts to the new litter type gradually. Once the litter type is substituted, the training process is complete as in step 499. One example of successful training is that the dog 302 makes the trip to the litter box 102. When the dog 302 makes the trip to the litter box 102 on its own, confinement is decreased. Another example of successful litter training is that the dog 302 eliminates on cue from the trainer. At the beginning of the training method, the dog 302 has not been trained and the method proceeds according to a schedule as in step 408.

In one embodiment, determination of whether it is time for the dog 302 to eliminate waste occurs at step 408. This determination is made according to a prescribed schedule. When the schedule indicates it is time for the dog to eliminate, the trainer places the dog 302 in the litter box 102. If the dog is in the enclosure 100, the trainer opens the lid 112, and then puts the dog 302 into the litter box 102.

The schedule includes specified times for events such as, waking, meals, play time, nap time, and the like. The events occur at regular intervals during the training period. The training period varies from a few days to a week or more. The schedule provides consistency of environment and circumstances for the dog 302. Schedule consistency includes feeding the dog 302 at or near the same time daily since dogs 302 tend to eliminate waste shortly after meals. Feeding the dog 302 at the same time daily also helps their elimination habits to become predictable. For example, the dog 302 is fed twice daily at breakfast and at dinner. After each of the two feedings, it is likely that the dog 302 will eliminate. The trainer watches for signs that the dog 302 is ready and then places the dog in the litter box 102. The schedule is developed and adapted to suit the trainer.

The dog 302 is kept on a consistent schedule for the entirety of the training period. During the training period the dog 302 uses the litter box 102 rather than going outside. The dog 302 uses the litter box 102 until the litter training is successful. Using the litter box 102 rather than going outside or elsewhere reinforces that the litter box 102 is the place to eliminate.

In one embodiment, the schedule includes placing the dog 302 into the litter box 102 at certain periods as in step 410. These placements occur (1) upon waking, (2) after breakfast, (3) during noon play time, (4) after dinner, (5) and during evening play time prior to going to sleep. For example, upon waking at 6:00 AM, the dog 302 is immediately placed into the litter box 102. After breakfast, the trainer watches the dog 302 for 10-15 minutes and observing for any signals or behavior as indication that the dog 302 needs to eliminate. Exemplary signals include circling, sniffing around, etc. as if the dog 302 is searching for a place to go. Upon noticing a signal or unusual behavior, the trainer places the dog 302 into the litter box 102. An extended nap and/or quiet time follows after breakfast.

During a noon play period, the dog 302 is frequently placed into the litter box 102. If the dog 302 exits the litter box 102, she is placed back into it after a short duration. This process continues until the dog 302 eliminates waste or until it is apparent that the dog 302 will not eliminate. Another nap or quiet time occurs between noon play time and dinner at approximately 5:00 PM. As after breakfast, the trainer watches the dog 302 after dinner for 10-15 minutes and observing for any signals or behavior as indication that the dog 302 needs to eliminate. The trainer places the dog into the litter box 102 upon an indication.

During evening play time, as during noon play time, the trainer frequently places the dog 302 into the litter box 102 until the dog 302 either eliminates or until it is apparent that there is no need.

In other embodiments, the schedule is adjusted so that the meal times and play times are according to trainer preference. In such embodiments, the dog 302 is frequently placed into the litter box 102 during periods of activity, and the dog 302 is watched for activity/behavior that suggests a need to eliminate for a period of time after meals.

In one embodiment, the trainer provides a verbal instruction when placing the dog 302 into the litter box 102. The verbal instruction includes a key word or phrase that trains the dog 302 to eliminate on cue. In various embodiments, the verbal instruction is “Go to the bathroom,” “Go potty,” and the like.

After placing the dog into the litter box 102, the dog 302 is observed for successful elimination in step 412. Upon elimination, the dog 302 is praised in step 414. The trainer praises the dog 302 both during and after eliminating. Using a key word or phrase repetitively such as, “Good girl,” or “Good boy,” reinforces the training. In some embodiments, a reward or treat is also given during step 414. The dog 302 is removed from the litter box 102 at step 416 after the praise is given. In some cases, the dog 302 will exit the litter box 102 on its own during the excitement. If there is no success, the dog 302 is removed from the litter box 102 once it becomes apparent that there is no need to eliminate. The process continues in accordance with the schedule. That is, the dog 302 is observed for signs of going to the litter box 102 on its own, and/or placed in the litter box 102 at scheduled times/events.

During litter training, dogs 302 occasionally have accidents that do not fit the schedule. Even though it is not time to eliminate, when the dog 302 has a urine accident as in step 418, the trainer uses the accident as a training opportunity. The urine is cleaned and some of the residue is placed in the litter box 102. In one embodiment, the trainer cleans the urine with a paper towel and places the paper towel on top of the litter in the litter box 102 as in step 420. The dog 302 is placed in the litter box 102, and since the dog 302 recognizes its own scent on the paper towel, it learns to return to the litter box 102 to eliminate.

Correction occurs when the dog 302 has an accident rather than after the accident. Upon noticing the dog 302 eliminating someplace other than the litter box 102, the trainer calmly and firmly says “No,” or something similar, then as the dog 302 is eliminating, placing the dog 302 into the litter box 102. When the dog 302 is finished, praise and reward are due as above.

From the foregoing description, it will be recognized by those skilled in the art that a litter box 102 and an enclosure 100 along with a method for litter training a dog 302 to use the litter box 102 have been provided. The litter box 102 can be used with or without the enclosure 100.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for receiving waste of domesticated animals, said apparatus comprising:
a floor having a first dimension and a second dimension;
four walls joined to said floor, two of said walls corresponding to said first dimension, two of said walls corresponding to said second dimension, said floor and said walls defining a floor space within the apparatus;
a door affixed to an opening in one of said walls, said door selectively providing access to the apparatus;
a litter box for receiving waste of domesticated animals, said litter box removable from the apparatus, said litter box having a first dimension of said litter box and a second dimension of said litter box, said first dimension of said litter box corresponding approximately to said second dimension of said floor, said second dimension of said litter box being approximately one-third of said first dimension of said floor, such that said litter box fits lengthwise across said second dimension of said floor at an end of the apparatus, wherein said litter box occupies approximately one-third of said floor space; and
a lid joined to one of said walls, said lid openable for placement and retrieval of said litter box within the apparatus.

2. The apparatus of claim 1 wherein said second dimension of said floor is less than an opening between two living spaces within a dwelling.

3. The apparatus of claim 1 wherein said litter box further comprises:
a first panel having a first height;
a second panel opposite said first panel, said second panel having a second height such that said first height is approximately one-fourth of said second height;
a third panel and a fourth panel of said second height, said third panel opposite said fourth panel, said third and fourth panels being joined adjacently to said first and second panels; and
a floor member joined to said first, second, third, and fourth panels to define a watertight container, said watertight container having an opening proximate said first panel for entry to and exit from said litter box.

4. The apparatus of claim 3 wherein said first height is approximately one-third of a height for an animal in standing position on all legs, wherein said litter box is configured for use by said animal.

5. The apparatus of claim 3 wherein said second height exceeds a height for an animal in standing position on all legs, wherein said litter box is configured for use by said animal.

6. The apparatus of claim 3 wherein said second, third, and fourth panels are of sufficient height to be a barrier for an animal that lifts a leg to relieve itself, wherein said litter box is configured for use by said animal.

7. The apparatus of claim 3 wherein said second, third, and fourth panels are of sufficient height to be a barrier whereby kicked litter stays within said litter box upon an animal kicking litter while exiting via said opening, wherein said litter box is configured for use by said animal.

8. A litter box for receiving waste of domesticated animals, the litter box comprising:
a floor member having a first dimension and a second dimension;
a first panel of said first dimension, said first panel having a first height;
a second panel of said first dimension, said second panel opposite said first panel, said second panel having a second height, said first is approximately one-fourth of said second height;
a third panel and a fourth panel of said second dimension and said second height, said third panel opposite said fourth panel, said third and fourth panels being joined adjacently to said first and second panels; and
said floor member joined to said first, second, third, and fourth panels to define a watertight container, said watertight container having a top opening and a passage opening proximate said first panel, said passage opening configured for entry to and exit from the litter box.

9. The litter box of claim 8 wherein said first height is approximately one-third of a height for an animal in standing position on all legs, wherein the litter box is configured for use by said animal.

10. The litter box of claim 8 wherein said first height is less than a distance extending ventrally from an abdomen of an animal to said floor member, for said animal in standing position on all legs on said floor member, wherein the litter box is configured for use by said animal.

11. The litter box of claim 10 wherein said second height exceeds a height for an animal in standing position on all legs, wherein the litter box is configured for use by said animal.

12. The litter box of claim 8 wherein said second, third, and fourth panels are of sufficient height to be a barrier for an animal that lifts a leg to relieve itself, wherein the litter box is configured for use by said animal.

13. The litter box of claim 8 wherein said second, third, and fourth panels are of sufficient height to be a barrier whereby kicked litter stays within the litter box upon an animal kicking litter while exiting via said passage opening, wherein the litter box is configured for use by said animal.

14. The litter box of claim 8 further comprising an apparatus that includes:
four walls, wherein said walls are made of a see-through material;
a floor joined to the walls, said floor and said four walls forming a watertight container; and
a lid for insertion and removal of the litter box from said apparatus;
wherein the litter box occupies approximately one-third of said floor.

15. A method for litter training an animal such as a dog, said method comprising the steps of:
a) preparing a litter training environment that includes a confined area for the animal, wherein said preparing step includes:
a1) selecting a litter box that includes (i) an opening of height low enough that the animal can enter or leave said litter box without stumbling or jumping, and (ii) at least one panel sufficiently taller than said opening so that said panel is operable to prevent litter from exiting said litter box by kicking when the animal exits via said opening;
a2) selecting a confined area for said litter box;
a3) placing said litter box in said confined area;
a4) placing litter in said litter box, said litter selected to be non-clumping; and
a5) placing the animal within said confined area;
b) interactively training the animal for a training period until the litter training is complete, via the steps of:
b1) defining a schedule that includes expected elimination times for the animal, wherein said elimination times derive from specified events that occur at regular intervals during said training period, wherein said specified events include (i) waking, (ii) feeding, (iii) play time, and (iv) before sleeping;
b2) placing the animal in said litter box at each expected elimination time, and removing the animal from said litter box if no elimination occurs;
b3) upon successful elimination by the animal, providing verbal praise to the animal, and removing the animal from said litter box;
b4) observing the animal for indications that litter training is complete; and
b5) continuing with steps b2) through b4) until litter training is complete.

16. The method of claim 15 further comprising the steps of:
a) selecting an enclosure that includes see-through walls, a watertight floor, and a lid for insertion and removal of said litter box, wherein said litter box occupies approximately one-third of said floor, wherein said enclosure defines said confined area;
b) placing said litter box in said enclosure; and
c) placing the animal in said enclosure.

17. The method of claim 15 further comprising placing said enclosure in a location substantially near a trainer that is litter training the dog.

18. The method of claim 15 further comprising placing the animal in said litter box upon observation of behavior of the animal that signals that the animal is ready to eliminate waste.

19. The method of claim 15 further comprising cleaning urine waste and placing residue in said litter box, upon discovery of an accident.

20. The method of claim 15 further comprising replacing said litter gradually from non-clumping to a type of litter selected by a trainer.
